(19) United States
(12) Patent Application Publication
(10) Pub. No.: US 2020/0013269 A1
(43) Pub. Date: Jan. 9, 2020

(54) Alarm Initiated Power Disconnects With Backups And Redundancy

(71) Applicants: Ronald Walter Sicking, Whitesboro, TX (US); Yvonne Marie Sicking, Whitesboro, TX (US); John Garry Myers, Gainesville, TX (US)

(72) Inventors: Ronald Walter Sicking, Whitesboro, TX (US); Yvonne Marie Sicking, Whitesboro, TX (US); John Garry Myers, Gainesville, TX (US)

(21) Appl. No.: 15/998,138

(22) Filed: Jul. 9, 2018

(51) Int. Cl. G08B 17/10; G08B 21/14

(52) U.S. Cl. CPC G08B 17/10; G08B 21/14

(57) ABSTRACT

A method of steps and a system of components which detects and responds to smoke, CO, and/or fire hazard emergency alarm signals (loud audio noise and/or bright strobe lights) and then provides a shut-off of electrical power and/or fuel gas (e.g. natural gas or propane) as well as other types of power and energy for safety's sake. The present invention is improved over the current product offerings and state of the art through increasing the reliability of alarm signal detection by utilizing redundancy and providing primary and backup sensor functionality for both of the possible commonly intended alarm signal outputs instead of monitoring for just one. This invention also includes a method of steps and a system which further improves reliability by adding additional redundancy and backups through detecting and responding to the unobvious but real by-product alarm signals which are: 1. the vibration of the audible alarm mechanism and 2. the electricity flowing in or to the activated alarm.

### BACKGROUND OF THE INVENTION

### Field of the Invention

This invention relates to methods and systems which sense and detect smoke, fire, or Carbon Monoxide alarm signals and then, automatically disconnect or block the provision of electric power and other fuels, such as propane or natural gas, at predetermined junctions for the sake of safety and minimization of the hazard or dangerous condition.

### State of the Art

Virtually no single event can cause as much destruction or engender a feeling of terror in an individual than can a fire. In only 3 short months, from Jan. 1, 2017 to Mar. 30, 2017 in the United States, there were 711 civilian home fire fatalities reported by U.S News media according to the U.S. Fire Administration (USFA).

Historically, according to statistics from the USFA the United States has one of the highest incidences of fire deaths in the industrialized world with over 3,275 deaths (2014) reported each year and over 100 firefighters killed. There were 1,298,000 fires in the United States in 2014. On average, fire is responsible for more deaths than all other natural disasters combined. Many of these deaths, over 80%, occur in the home, making fire the third leading cause of accidental death in the home. Also, according to the USFA, cooking, heating, and electrical malfunctions add up to be the leading cause of residential fires and fire injuries. The majority of these situations involved unattended stoves and other devices. In addition to the deaths and extremely painful fire related injuries (burns), fires cause a loss of money (financial hardship) of more than $11,600,000,000 ($11.6 billion) per year (2014). It is believed that many fires go unreported, accounting for untold additional injury and financial loss. (Source: National Fire Protection Association)

The developed and industrialized world is replete with products that detect and indicate hazards and fires as well as sound alarms and light-up the air with strobe lights, however, massive amounts of fire damage, deaths, and injuries still continue year after year. There are automatic fire extinguishing systems available that are able to extinguish all of the fire types known, however, massive amounts of fire damage, deaths, and injuries still continue year after year. This would lead a reasonable person to conclude that there must be a deficiency in the solutions offered in the market-place.

It is a common occurrence in households around the world, that a house fire begins with an unattended or malfunctioning appliance, particularly a stove. The heat-producing elements of a stove, whether they are gas or electric, can be the source of fires which begin and grow at the stove, sustained by the continued supply of power and/or fuel gas to the stove. Many fires which begin on the stove top or in the oven would not grow to dangerous proportions but for the fact that the power and gas supplies maintain the oven and/or burner heating elements at elevated temperatures. The temperatures sustain the existence and growth of the fire such that it spreads beyond the stove to nearby areas having sufficient presence of flammable materials such that ultimately, the fire can only be managed by emergency measures, if at all. The occurrence is common and similar when a furnace, portable heaters, or other stand-alone electric and/or gas-powered appliances malfunction while being unattended.

The role of the continued operation of the stove and/or other malfunctioning appliances in the growth of the fire to damaging, emergency proportions is well understood. A large number of residential and commercial fires could be prevented if they had been stopped from proliferating during their early stages. As these types of fires proliferate when they are unattended, it is important to extinguish or suppress these fires quickly and automatically. Otherwise, within minutes of bursting into flames, a fire may consume the contents, walls and ceiling of the room where the fire started and the combination of heat, smoke and carbon monoxide can kill everyone in the area.

Generally smoke detectors are used to detect the fires and issue an audible and/or visual alarm to alert individuals in the vicinity that a fire is present, allowing for actions to be taken to extinguish the fire. However, if no one is around to hear and/or see the alarm, the fire will continue to burn causing significant damage. Thus, most homes remain at risk for appliance-initiated fire and the resultant devastation.

Natural disasters such as earthquakes, tornadoes and hurricanes are often followed by devastating fires which endanger survivors immobilized by rubble and complicate recovery efforts. These fires can result from electrical appliances such as televisions, clothes dryers and other appliances, particularly those that have the ability to store a charge when turned off. Other electrical appliances which are hazardous during an earthquake are those which have heating elements which may remain at high temperature even after the appliance tips over or which have elements which could come into contact with flammable materials during or after the disaster event.

Many standard alarm systems have been developed and are currently on the market which provide both, one, an alarm system for alerting the individuals present in a particular building or similar structure of the presence of a fire, and then two, communicating this information to the proper authorities, such as the fire department and the police department.

Additionally, there are patents which claim an alarm activated electrical power isolating safety system which senses the evidence of a fire or a fire that is just starting via smoke detector, heat detector, or carbon monoxide detector, then sounds an alarm or sends a signal to an alarm, which in turn sends a signal to a power disconnection device in the main circuit breaker panel or sends a signal to a power disconnection device which is inside a power outlet or sends a signal to a power disconnection device which plugs into a wall outlet and is part of an outlet strip or is part of a self-contained portable plug-in receptacle which then acts as an electric outlet. Examples of these patents include: US20150061861, EP2860713A1, US20130063848, U.S. Pat. No. 8,836,522, GB2407719, U.S. Pat. No. 5,508,568, US20090312883, U.S. Pat. No. 5,489,889, Australia 2003200895, U.S. Pat. No. 8,446,048, US20100073174, US4659909, U.S. Pat. Nos. 4,635,040, 4,737,769, 8,450,879, 6,130,412, GB2475931, GB2474479, US20060044133, US20100109887, US20110170377, US20120320484, US20130093593, and U.S. Pat. No. 8,482,884.

These patents which claim devices that automatically shut-off electrical power upon detecting smoke or evidence of a fire have made great strides in the technology available to combat fires which involve and “unattended hazardous situation” or one in which people are absent, however, even with the existence of the aforementioned and listed patents, massive amounts of fire damage, deaths, and injuries still continue year after year. This fact shows a glaring and bold indication which clearly underscores the fact that the current state of the art if deficient and in need of improvement.

Another indication of the fact that the current state of the art is deficient and in need of improvement is the fact there is the lack and absence of alarm triggered automatic electrical power cut-off and gas-power disconnects and isolation systems which are readily available to consumers on a mass scale and which have been successfully mass-produced and mass-distributed. If the current patent offerings provided automatic power disconnection systems that were universal enough, reliable enough, and effective enough, just using the reasoning powers of common-sense, one would have to conclude that they would be as common-place as the standard smoke alarm. As of the date of this writing, there are no such systems commonly available at the large home-improvement product and home-safety product retailers. This void in the market-place of readily available mass produced consumer products indicates that there are problems with the current product offerings and the current state of the art and that there is a need for a much improved system of electric power source and gas power source isolation and disconnection for the sake of fire and hazard prevention and fire and hazard cessation.

When it comes to matters of saving the lives of people, beloved pets, and valued personal property from dangerous hazards such as fire, the reliable function of the system and/or method is of the highest priority. The current state of the art is lacking in terms of reliability because it doesn't take into account the fact that, sometimes, components fail to perform as designed. Each component within a system is made to a design which contains tolerances. Each dimension of each component of a system is required to be within a given tolerance. Material and process specifications also allow variance and tolerances. Sometimes people make mistakes and sometimes, manufacturers make mistakes. There can even be mistakes in the material specified. All of these mistakes can result in defects. Some defects in the components cause them to fail at their intended function. Due to the inherent imperfection in people and products, even, with high quality standards and stringent quality controls, there needs to be a system and methods that include back-ups and redundancy. The current state of the arts fails to address the need for “back-up” functionality and methodology and redundant components, systems, and methods in order to ensure the very high reliability that is needed when people's lives are at stake.

### BRIEF SUMMARY OF THE INVENTION

This present invention is directed to Methods, Systems, Compositions, Mechanisms and Embodiments which detect and measure alarm signals from any standard (non-custom) or custom fire and/or smoke hazard alarm and determine that a hazard or fire alarm is active and in progress. This present invention then interprets and evaluates the alarm sensors' input and responds to the detected alarm signal by energizing a switch or mechanism or instrument which automatically activates an electric power or electric supply disconnect device or a fuel-gas supply disconnect device.

This present invention focuses on dramatically improving the current state of the art specifically in the areas of reliability and effective functioning because it is capable of detecting the fire hazard alarm signals and outputs in 4 different ways using back-up methods and functions that create redundancy and therefore statistically reduces the chance of missing an alarm almost to zero. This present invention senses both the standard intentional alarm outputs of: 1, a bright strobe light or just a bright light and 2. a loud alarm sound as well as the non-obvious but ultra-reliable alarm outputs of 3. vibration of the alarm body or vibration of the sound producing component, and 4. the electric current flowing through the alarm when the intentional strobe and/or sound alarm are activated. The electric current is sensed by one of 2 ways: 1. the extra magnetic field and flux in close proximity to the alarm body, and 2. directly electrically connecting into the alarm circuit or wiring and measuring the current flowing when the alarm is activated.

This invention will reliably and effectively sense when an activated fire alarm is sending out an alarm signal, and then automatically control and/or disconnect the power or fuel supply which is preselected to be controlled and/or disconnected. This invention is not limited to disconnecting only electric power or fuel gas, but, includes all types of fuel and power sources which are capable of contributing to the initiation or propagation of a fire.

### BRIEF DESCRIPTION OF THE FIGURES AND DRAWINGS

FIG. 1: Method System Overview: This Figure shows a block diagram of the Method at the system level which utilizes redundancy to create great reliability.

FIG. 2: Apparatus System Overview: This Figure shows a block diagram of the Apparatus and Components at the system level which utilizes redundancy to create great reliability.

### DETAILED DESCRIPTION OF THE INVENTION

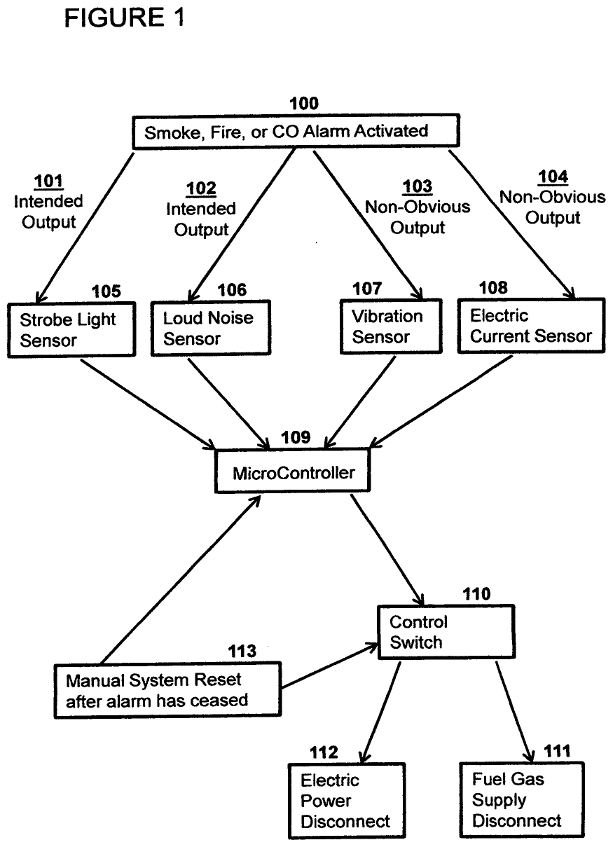

FIG. 1 depicts the Method Overview which relates to the steps of the method in a block diagram flow-chart form. The method begins with an activated fire, heat, smoke, or CO alarm 100. One configuration of the method of this invention provides the hazardous condition sensor sensing the evidence of the hazardous condition such as a smoke detector and then sounding or producing the alarm. In another configuration of the method of this invention the hazardous condition sensor or detector is already in existence. Either way, the detector emits an alarm signal (whether part of this invention or part of another preexisting system), and this is the first step in the method. In alternative methods, the alarm signal can be any type of output signal or energy output including these examples: audible, luminous, a wireless radio signal sent to a remote receiver, or a wired electrical current sent to a receiver. The alarm signal can even be a cellular signal, microwave beam energy or a silent alarm. The preferred method of invention has sensors which are adapted to the intended signal outputs such as a strobe light 105 and a loud noise 106. This preferred invention also has sensors which are adapted to the alarm's vibration 107 and internal electric current 108 as a result of the alarm creating the output alarm signals. In alternative configurations, the sensors are chosen and incorporated into the method specifically to match the intended alarm outputs and also the by-product non-obvious energy outputs. The vast improvement of this invention over the current state of the art is that this invention utilizes all of the outputs of the alarm in a redundant configuration to determine when a signal is being emitted with great reliability. These outputs include the ones that are designed into the alarm device and intended 101 102 to be used as alarm signals and also includes the byproducts of the intended alarm signals which result in non-obvious detectable energy 103 104. This creates unequalled reliability over the current state of the art. The steps in this invented method continue with each sensor providing input to a microcontroller 109 or any type of controller which is capable of processing the input. In the preferred method the microcontroller is custom programmable. However, in alternative configurations the program is hardwired by specific circuitry and components. If the alarm signal meets the criteria in the programming or in the circuitry, the microprocessor outputs a signal to the control switch 110. The control switch in the preferred configuration of the method is a solenoid which moves and activates another switch that activates an electric power disconnect 112 or a fuel gas supply disconnect 111. This invention is not limited to disconnecting only electric power or fuel gas, but, includes all types of fuel and power sources which may contribute to the start or growth of a fire. The last in the steps of the method after the utility, energy, and power disconnect or disconnects are activated is an inspection of the system, an inspection of the building or grounds, and then a manual reset of microprocessor (which resets the sensors), a manual reset of the control switch, and if necessary, a manual reset 113 of the utility disconnects. Another configuration of this invented method includes an automatic reset of all the method steps, but, only after checks have been performed to determine that the hazardous condition is finished and inactive.

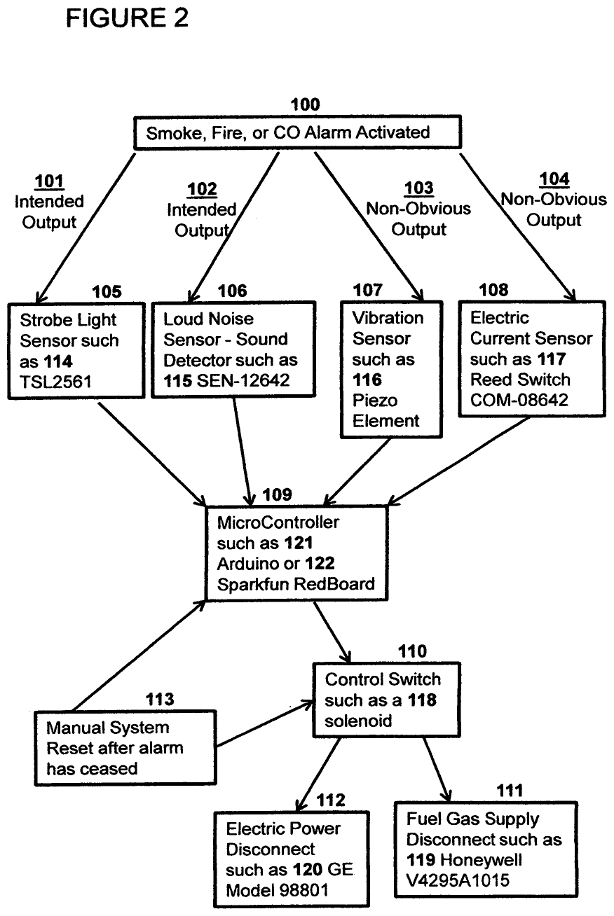

FIG. 2 depicts the Apparatus and Component System Overview which, when combined with this detail description, discloses the preferred configuration. However, there are many functional embodiments and configurations of this invention which can consist of different components as long as the system function is maintained in accordance with this disclosure. FIG. 2 provides the same system level information as FIG. 1, but, FIG. 1 shows the method and steps while the focus of FIG. 2 is the apparatus and component arrangement and function. This invention is not limited to disconnecting only electric power or fuel gas, but, includes all types of fuel, power, and energy sources which are capable of contributing to the origin or propagation of a fire.

Additionally, the scope of this present invention includes the fire hazard detection device and the device that produces the alarm signal in alternative embodiments.

Per FIG. 2 this present invention is intended to utilize any of the intended activated alarm 100 output signals 101 102 combined, in any configuration, with the unintended and non-obvious output 103 104 energies that can be read or received as an alarm signal. In all configurations of this invention, a minimum of 2 alarm signals are received by the brain or micro-controller of the invention to create a back-up or redundant path for success accomplishment of the inventions purpose. The 2 signals can be any combination of the intended and non-obvious signals. Some alternative configurations of this invention will include 3 signals and some will include all 4 utilized in a redundant configuration.

The strobe light sensor 105 used in one embodiment of this invention is a 114 model TSL2561 from Sparkfun Electronics. The schematic diagram along with wiring instructions and programming code are available from Sparkfun Electronics. This is just an example of the component that can be used and does not exclude any other component which is able to perform the function of sensing an alarm signal which consists of bright light or pulsing bright lights.

The loud noise sensor and sound detector 106 used in one embodiment of this invention is a 115 model SEN-12642 from Sparkfun Electronics. The schematic diagram along with wiring instructions and programming code are available from Sparkfun Electronics. This sensor is just an example of the component that can be used and does not exclude any other component which is able to perform the function of sensing an alarm which consists of consistent repetitive or pulsing loud noises in alternative embodiments.

The vibration sensor 107 used in one embodiment of this invention is a 116 Piezo Element from Sparkfun Electronics. The schematic diagram along with wiring instructions and programming code are available from Sparkfun Electronics. This is just an example of the component that can be used and does not exclude any other component which is able to perform the function of sensing vibration in alternative embodiments.

The electric current sensor 108 used in one embodiment of this invention is a 117 Reed Switch from Sparkfun Electronics, part number COM-08642. The schematic diagram along with wiring instructions and programming code are available from Sparkfun Electronics. This is just an example of the component that can be used and does not exclude any other component which is able to perform the function of sensing an applied magnetic field due to electric current in alternative embodiments. In another alternative embodiment the function of sensing electric current can be completed by using a probe directly inserted into the wiring or circuitry of the hazard alarm device.

The 109 Micro-Controller used in the preferred embodiment is a 122 RedBoard from Sparkfun Electronics, however, any micro-controller from the 121 Arduino line of products or any device capable of the same functions as the RedBoard is included within the scope of this invention. This includes custom designed and custom manufactured programmable controller devices.

The 110 control switch used in the preferred embodiment is a 118 5V solenoid with 6mm plunger travel. This solenoid, the remote control switch and the custom designed prototype mounting adapter made of ABS plastic are shown in FIG. 3. However, the scope of this invention includes any device that is capable of being activated by the controller and able to send energy to a power disconnecting mechanism or shut-off device.

In the preferred embodiment two examples of power disconnect/shut-off devices 111 112 are given in FIG. 2. In the preferred embodiment, the electric power disconnect is a 120 GE Model 98801 and the fuel gas supply disconnect is a 119 Honeywell V4295A1015. However, the scope of this invention in alternative embodiments includes any device which is capable of disconnecting or shutting-off power or fuel capable of contributing to a fire.

The last in the part of this system after the utility disconnect or disconnects are activated is an inspection of the system, an inspection of the building or grounds, and then a 113 manual reset of microprocessor (which resets the sensors), a manual reset of the control switch, and if necessary, a manual reset of the utility disconnects. Another configuration of this invention includes an automatic reset of all the components which require resetting in order to resume normal function, but, only after checks have been performed to determine that the hazardous condition is finished and inactive. These checks can be performed using manual means, components and devices or automatic or automated means, components, and devices.

The following is the actual programming code of the functional prototype of this present invention. This code does not limit the scope of this invention and is only one of a number of codes which can be used for this invention. It is also possible to use a controller that does not require programming, but, is functional through advanced circuitry or some other means of making decisions such as artificial intelligence.

We claim:

1. A method of stopping the propagation of a fire hazard or fire related dangerous condition and preventing the supply of fuel, utility power, or energy with the capability to propagate and contribute to a fire, the method comprising the steps:
a) sensing and detecting the evidence of a fire hazard or fire related dangerous condition;
b) processing this evidence automatically;
c) responding to the evidence with an alarm signal that has at least two intended and obvious outputs;
d) detecting and identifying both of the intended alarm signal outputs in a redundant configuration for increased reliability in signal identification;
e) processing these output detections automatically;
f) and activating predetermined utility power disconnects devices, fuel supply disconnect devices, energy disconnect devices, and power transmission disconnect devices according to the automatic processing parameters.

2. The method according to claim 1 wherein the two intended alarm signal outputs are and audible alarm and a luminous alarm.

3. The method according to claim 2 wherein the detecting and identifying of an alarm signal includes a third redundantly configured output that is unintended and non-obvious in that it is the vibration of the intended audible signal output mechanism.

4. The method according to claim 2 wherein the detecting and identifying of an alarm signal includes a third redundantly configured output that is unintended and non-obvious in that it is the electric current flowing in either of the two intended alarm signal output devices or both simultaneously.

5. The method according to claim 3 wherein the detecting and identifying of an alarm signal includes a fourth redundantly configured output that is unintended and non-obvious in that it is the electric current flowing in either of the two intended alarm signal devices or both at the same time.

6. The method according to claim 4 wherein the detecting and identifying of an alarm signal includes a fourth redundantly configured output that is unintended and non-obvious in that it is the vibration of the intended audible signal output mechanism.

7. The method according to claim 1 wherein the step of responding to the evidence of a fire hazard includes outputting only one intended and obvious alarms signal.

8. The method according to claim 7 wherein the detecting and identifying of an alarm signal includes detecting and identifying a second redundantly configured output that is unintended and non-obvious in that it is the electric current flowing in the intended and obvious alarm signal as it outputs.

9. A method of stopping the propagation of a fire hazard or fire related dangerous condition and preventing the supply of fuel, utility power, or energy with the capability to propagate and contribute to a fire, wherein a fire or smoke hazard alarm signal device is in the process of outputting two or more intended and obvious alarm signals, the method comprising the steps:
a) detecting and identifying both of the intended alarm signal outputs in a redundant configuration for increased reliability in signal identification;
b) processing these alarm signal detections automatically;
c) and activating predetermined utility power disconnect devices, fuel supply disconnect devices, energy disconnect devices, and power transmission disconnect devices according to the automatic processing parameters.

10. The method according to claim 9 wherein the two intended alarm signal outputs are an audible alarm and a luminous alarm.

11. The method according to claim 10, wherein the detecting and identifying of an alarm signal includes a third redundantly configured output that is unintended and non-obvious in that it is the vibration of the intended audible signal output mechanism.

12. The method according to claim 10, wherein the detecting and identifying of an alarm signal includes a third redundantly configured output that is unintended and non-obvious in that it is the electric current flowing in either of the two intended alarm signal output devices or both simultaneously.

13. The method according to claim 11, wherein the detecting and identifying of an alarm signal includes a fourth redundantly configured output that is unintended and non-obvious in that it is the electric current flowing in either of the two intended alarm signal output devices or both simultaneously.

14. The method according to claim 12, wherein the detecting and identifying of an alarm signal includes a fourth redundantly configured output that is unintended and non-obvious in that it is the vibration of the intended audible signal output mechanism.

15. The method according to claim 9 wherein the step of detecting and identifying both of the intended alarm signal outputs includes only detecting and identifying one intended and obvious alarm signal output.

16. The method according to claim 15 wherein the step of detecting and identifying of an alarm signal includes detecting and identifying a second alarm output that is unintended and non-obvious in that it is the electric current flowing in the intended and obvious alarm signal as it outputs.

17. For the sake of stopping the propagation and growth of a fire related hazardous or dangerous condition or situation and preventing the supply of fuel, utility power, energy, or any type of power transmission into a hazardous environment, an apparatus comprising:
a) a luminous alarm signal sensor;
b) an audible alarm signal sensor;
c) intelligent circuitry or a programmable central control unit;
d) control switching;
e) disconnect devices;
f) and a functional configuration in which the luminous alarm signal sensor and audible alarm signal sensor are configured in a redundant arrangement.

18. The apparatus according to claim 17 comprising a vibration sensor, arranged in a redundant configuration with the existing sensors, which detects and identifies the non-obvious and unintended output signal of vibration due to the audible alarm signal producing mechanism.

19. The apparatus according to claim 17 comprising an electric current sensor, arranged in a redundant configuration with the existing sensors, which detects and identifies the non-obvious and unintended output signal of the electric current flowing in either of the two intended alarm signal output devices or both simultaneously.

20. The apparatus according to claim 18 comprising an electric current sensor, arranged in a redundant configuration with the existing sensors, which detects and identifies the non-obvious and unintended output signal of electric current flowing in either of the two intended alarm signal output devices or both simultaneously.

21. The apparatus according to claim 19 comprising a vibration sensor, arranged in a redundant configuration with the existing sensors, which detects and identifies the non-obvious and unintended output signal of vibration due to the audible alarm signal producing mechanism.

22. The apparatus according to claim 17 omitting the luminous alarm signal sensor, but, comprising the audible alarm signal sensor and a vibration sensor, arranged in a redundant configuration with the existing sensor, which detects and identifies the non-obvious and unintended output signal of vibration due to the audible alarm signal producing mechanism.

23. The apparatus according to claim 17 omitting the luminous alarm signal sensor, but, comprising the audible alarm signal sensor and an electric current sensor, arranged in a redundant configuration with the existing sensor, which detects and identifies the non-obvious and unintended output signal of electric current flowing in the audible intended alarm signal output device.

24. The apparatus according to claim 22 also comprising an electric current sensor, arranged in a redundant configuration with the existing sensors, which detects and identifies the non-obvious and unintended output signal of electric current flowing in the audible intended alarm signal output device.

25. The apparatus according to claim 23 also comprising a vibration sensor, arranged in a redundant configuration with the existing sensors, which detects and identifies the non-obvious and unintended output signal of vibration due to the audible alarm signal producing mechanism.
